(19) United States
(12) Patent Application Publication
(10) Pub. No.: US 2023/0304737 A1
(43) Pub. Date: Sep. 28, 2023

(54) BIOMASS SMOKER-DRYER APPARATUS AND RELATED METHODS

(71) Applicant: Michigan Medical Hemp LLC, Chesaning, MI (US)

(72) Inventor: Beau Parmenter, Henderson, MI (US)

(21) Appl. No.: 18/188,862

(22) Filed: Mar. 23, 2023

Related U.S. Application Data
(60) Provisional application No. 63/323,940, filed on Mar. 25, 2022.

(51) Int. Cl. F26B 23/02; F26B 21/10; A24B 3/12

(52) U.S. Cl. CPC F26B 23/02; F26B 21/10; A24B 3/12; F26B 2200/02

(57) ABSTRACT

Described herein are devices and methods for drying biomass using smoke. A device may include a housing configured to receive the biomass; at least one sensor in the housing and configured to measure a property of the biomass; a heat source thermally coupled to the housing and configured to apply heat to the housing and thus the biomass therein; and a smoke producing chamber fluidly coupled to the housing and configured to receive a burnable material therein.

### CROSS REFERENCE TO RELATED APPLICATION

This application claims priority benefits to U.S. Provisional Application Ser. No. 63/323,940, titled “Biomass Smoker-Dryer Apparatus and Related Methods,” filed on Mar. 25, 2022, the contents of which is herein incorporated by reference in its entirety.

### INCORPORATION BY REFERENCE

All publications and patent applications mentioned in this specification are herein incorporated by reference in their entirety, as if each individual publication or patent application was specifically and individually indicated to be incorporated by reference in its entirety.

### TECHNICAL FIELD

This disclosure relates generally to the field of agricultural processing devices, and more specifically to the field of agricultural product dryers. Described herein are systems and methods for drying biomass with smoke.

### BACKGROUND

Many crops, including (Cannabis sativa), hops (Humulus lupulus), and herbs (e.g., lavender, rose geranium, rosemary, basil, thyme, peppermint, chamomile, eucalyptus, buchu), need to undergo a drying or curing step after harvest in order to be commercially viable. During these steps, a substantial quantity of water content, sometimes upwards of 70% to 80% of the total weight of the plant, is removed from the crop. Traditional techniques for drying such crops include passive, ambient drying as well as active, heated methods.

Ambient drying generally involves spreading out the harvested biomass in a barn or warehouse and allowing the water content to evaporate slowly into natural air. Due to the lack of sophisticated automated or atmospheric control, this method leaves the conventional drying procedure subject to seasonal and local environmental factors, which can risk exposing the crop to mold and rot. In addition, conventional drying procedures generally utilize an extended drying time, which can vary and/or trend upward to complete an entire drying cycle. However, ambient drying is generally very gentle to the crop, meaning that desirable properties (e.g., colors, tastes, scents) or chemical content (e.g., various terpenes, some in trace quantities that impart the aforementioned desirable properties) remain unaffected, or only minorly so, throughout the process.

Active, heated methods accelerate the process by exposing the biomass to a source of heat and/or a circulating source of heated, dry air. While this can greatly expedite the process, the introduction of heat, often well over 100 degrees Fahrenheit (about 38 degrees Celsius), can often cause the degradation of certain physical properties or chemical content that is desired for particular uses of the crop. Therefore, without improvements to existing devices and methods for drying or curing biomass, farmers in some industries are left choosing between a slow, inefficient, and variable process and a faster but damaging alternative.

### SUMMARY

In some aspects, the techniques described herein relate to a device for drying biomass, including: a housing defining a cavity to receive and substantially enclose the biomass; at least one sensor in the housing and configured to measure a property of the biomass; a heat source thermally coupled to the housing, the heat source being configured to apply heat to the cavity of the housing and to the biomass therein; and a smoke producing chamber fluidly coupled to the housing, the smoke producing chamber being configured to receive a burnable material therein.

In some aspects, the techniques described herein relate to a device, wherein: the housing further includes a vent; and the smoke producing chamber is fluidly coupled to the housing by a channel having a first end opposite a second end, the first end being coupled to the housing and the second end being coupled to the smoke producing chamber. In some aspects, the techniques described herein relate to a device, wherein smoke is introduced to the cavity of the housing through the channel when the burnable material is burned within the smoke producing chamber.

In some aspects, the techniques described herein relate to a device, wherein the housing further includes a temperature sensor for measuring a temperature within the cavity of the housing. In some aspects, the techniques described herein relate to a device, further including a display configured to show one or more of: a temperature in the cavity of the housing and a duration of device operation.

In some aspects, the techniques described herein relate to a device, wherein the at least one sensor includes a spectrophotometer and the property includes a spectral reflectance. In some aspects, the techniques described herein relate to a device, wherein the at least one sensor includes an image sensor and the property includes a color property of the biomass.

In some aspects, the techniques described herein relate to a device, wherein the at least one sensor includes a moisture sensor and the property includes a moisture content of the biomass. In some aspects, the techniques described herein relate to a device, further including a processor communicatively coupled to the at least one sensor and configured to: receive a signal from the at least one sensor, process the signal, and output an indication of the property of the biomass. In some aspects, the techniques described herein relate to a device, wherein the processor is further configured to cause modification of operation of the heat source or modification of operation of the smoke producing chamber in response to the output.

In some aspects, the techniques described herein relate to a device, wherein: the property is a color property of the biomass; and the processor is further configured to: cause ceasing of operation of the heat source and cause ceasing operation of the smoke producing chamber when the indication of the property of the biomass indicates that at least a portion of the biomass is detected to be a predefined color. In some aspects, the techniques described herein relate to a device, wherein the predefined color is associated with a predefined moisture content corresponding to a completed drying cycle for the biomass.

In some aspects, the techniques described herein relate to a device, wherein the at least one sensor is a spectrophotometer installed in the housing, the spectrophotometer being configured to measure a spectral reflectance of the biomass. In some aspects, the techniques described herein relate to a device, wherein the burnable material is selected from: wood chips, wood pellets, sawdust, hemp, biomass, or peat. In some aspects, the techniques described herein relate to a device, wherein the heat source includes one of: a gas heat source and an electric heat source.

In some aspects, the techniques described herein relate to a method of drying biomass using a smoker, including: during a cycle: applying heat to the biomass within a chamber, the heat being applied at a temperature between about 37.8 degrees C. to about 148.9 degrees C.; and applying smoke to the biomass within the chamber, wherein the cycle has a duration of about 15 minutes to about 120 minutes, and wherein, at a completion of the cycle, the biomass has a moisture content of about 6% to about 12%.

In some aspects, the techniques described herein relate to a method, wherein the biomass includes seeds. In some aspects, the techniques described herein relate to a method, wherein the biomass includes hemp.

In some aspects, the techniques described herein relate to a method, wherein, at the completion of the cycle, the hemp includes a total farnesenes content of about 0.020% to about 0.040% by weight ratio, a total nerolidol content of about 0.4% to about 0.8%, and a total terpineol content of about 2.5% to about 5.75% by weight. In some aspects, the techniques described herein relate to a method, wherein the biomass includes Cannabis. In some aspects, the techniques described herein relate to a method, wherein the biomass before applying the heat and the smoke has a moisture content of about 20% to about 40%. In some aspects, the techniques described herein relate to a method, further including flavoring the smoke to flavor the biomass.

In some aspects, the techniques described herein relate to a method of drying biomass using a smoker, including: applying heat to the biomass at a temperature between about 37.8 degrees C. to about 148.9 degrees C.; applying smoke to the biomass; measuring a property of the biomass; in response to determining that a measurement associated with the measuring of the property is within a predefined threshold window, terminating the application of one or both of: the heat and the smoke.

In some aspects, the techniques described herein relate to a method, wherein the property includes a moisture content of the biomass; the measurement is a spectral reflectance measurement; and the predefined threshold window is a moisture content of about 6% to about 12%. In some aspects, the techniques described herein relate to a method, wherein the biomass includes seeds. In some aspects, the techniques described herein relate to a method, wherein the biomass includes hemp.

In some aspects, the techniques described herein relate to a method, wherein the biomass includes Cannabis. In some aspects, the techniques described herein relate to a method, wherein the biomass before applying the heat and the smoke has a moisture content of about 20% to about 40%. In some aspects, the techniques described herein relate to a method, further including flavoring the smoke to flavor the biomass. In some aspects, the techniques described herein relate to a method, wherein the property includes a moisture content. In some aspects, the techniques described herein relate to a method, wherein the property includes a temperature. In some aspects, the techniques described herein relate to a method, wherein the property includes a physical appearance. In some aspects, the techniques described herein relate to a method, wherein the property includes a brittleness temperature value.

In some aspects, the techniques described herein relate to a method of drying biomass using a smoker, including: applying heat to a wet biomass at a temperature between about 37.8 degrees C. to about 148.9 degrees C.; applying smoke to the wet biomass; and discontinuing one or both of: the heat and the smoke after about 15 minutes to about 180 minutes, wherein the wet biomass becomes a dry biomass having a moisture content of about 6% to about 12% after the completion of the application of the heat and the smoke. In some aspects, the techniques described herein relate to a method, wherein the wet biomass before applying the heat and the smoke has a moisture content of about 20% to about 40%.

The details of one or more implementations are set forth in the accompanying drawings and the description below. Other features will be apparent from the description and drawings, and from the claims.

### BRIEF DESCRIPTION OF THE DRAWINGS

The foregoing is a summary, and thus, necessarily limited in detail. The above-mentioned aspects, as well as other aspects, features, and advantages of the present technology are described below in connection with various embodiments, with reference made to the accompanying drawings.

FIG. 1 illustrates one embodiment of a biomass smoker-dryer device.

FIG. 2 illustrates a functional block diagram of connected computer modules of an embodiment of a biomass smoker-dryer device.

FIG. 3 illustrates one embodiment of a method for drying biomass with smoke.

The illustrated embodiments are merely examples and are not intended to limit the disclosure. The schematics are drawn to illustrate features and concepts and are not necessarily drawn to scale.

### DETAILED DESCRIPTION

The foregoing is a summary, and thus, necessarily limited in detail. The above-mentioned aspects, as well as other aspects, features, and advantages of the present technology will now be described in connection with various embodiments. The inclusion of the following embodiments is not intended to limit the disclosure to these embodiments, but rather to enable any person skilled in the art to make and use the contemplated features described herein. Other embodiments may be utilized, and modifications may be made without departing from the spirit or scope of the subject matter presented herein. Aspects of the disclosure, as described and illustrated herein, can be arranged, combined, modified, and designed in a variety of different formulations, all of which are explicitly contemplated and form part of this disclosure.

Disclosed herein are devices and methods for drying biomass, including that of harvested hemp. Many valuable crops need to be dried or cured after harvesting to be economically useful; however, preexisting methods are often either gentle but slow, or fast but damaging to the final product. The devices and methods described herein serve to provide an accelerated drying process that produces no substantial change in the valuable terpene content of the biomass. In some embodiments, the devices and methods described herein employ the use of smoke that, because of its own terpene and moisture content, succeeds in preserving the terpene content (and cannabinoid content in examples involving hemp), color, and structural durability of the biomass during the drying process. In some embodiments, the devices and methods described herein can impart additional properties on the biomass while drying or curing the biomass. In this manner, the devices and methods herein can produce a superior dried product more expediently than conventional drying technologies.

In the context of processing crop biomass, the terms “drying” and “curing” will be used interchangeably throughout this disclosure due to the immense functional similarity in performing these two processes. Technically, drying refers specifically to the removal of water from the biomass (e.g., product) whereas curing refers to the induction of an oxidative change within the biomass (e.g., product). However, curing in this context typically occurs alongside or as a result of drying and can be achieved simultaneously or subsequently with the devices and methods described herein. Therefore, the terms “drying” and “curing” will be used interchangeably or the use of one will be intended to also encompass the other.

As used herein, “moisture content” is calculated similarly to how wood moisture content is calculated. The percent moisture of the biomass is expressed as a percentage of the total weight of the biomass, including both the dry biomass material and the water and can be represented as follows:

mc=(Wg−Wo)/Wo*100

where, mc is the moisture content; Wg is the green (or wet) weight of the biomass; and Wo is the dry weight of the biomass.

### Devices

The devices described herein (e.g., device 100) may function to expediently dry plant biomass with insubstantial change to the terpene content of the biomass compared to conventional, slow drying methods. In some embodiments, the device is used for the drying of harvest hemp (Cannabis sativa) and/or marijuana (Cannabis indica) biomass (e.g., leaves, shives, fibers, seeds, etc.), but can additionally or alternatively be used for any suitable applications, including the drying of biomass of other plants, such as hops (Humulus lupulus) and herbs (e.g., for essential oils, lavender, rose geranium, rosemary, basil, thyme, peppermint, chamomile, eucalyptus, buchu). The device can be configured and/or adapted to function for any suitable operation involving the drying of plant biomass.

In some embodiments, the devices described herein are capable of applying heat and/or smoke to plant biomass during a drying operation or cycle of the device. In a “drying cycle,” the device applies a prescribed quantity of heat and/or smoke to the plant biomass for a predetermined duration of time and under specific parameters (e.g., temperature, humidity, etc. see below). These parameters can be set independently of or in relation to properties of the biomass to be dried (e.g., the biomass's total mass, percentage of moisture content, plant species, portion of plant, etc., see below). In some embodiments, these parameters are manually adjusted or entered into a computing device associated with the device by a user. In some embodiments, the device includes sufficient detectors to identify the relevant properties of the biomass and can automatically adjust the parameters of the drying cycle based on detecting a particular property. As used herein, a drying operation can include one or more drying cycles. In some embodiments, the temperature and/or quantity of smoke inside the device can be allowed to return to ambient conditions between cycles. Thus, since a drying operation, in some embodiments, can be a singular drying cycle, the terms will be used interchangeably herein. Although the term “drying cycle” is used herein, the drying cycle may refer to any number of cycles, any and all of which may include content drying steps and/or content smoking steps.

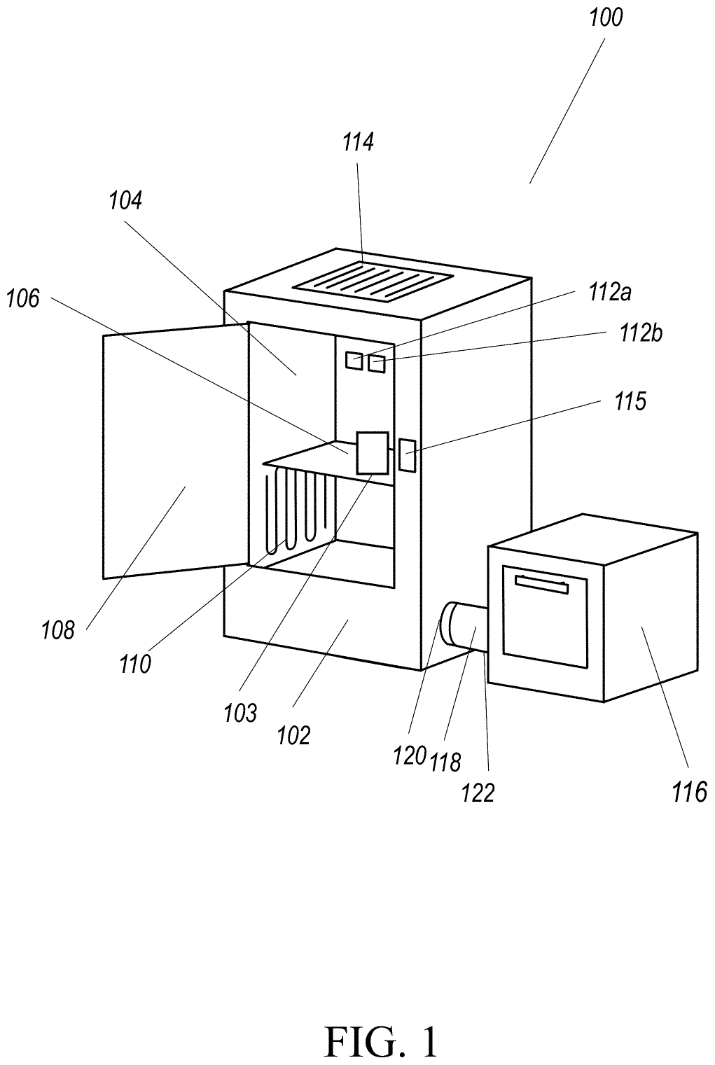

As shown in FIG. 1, a device 100 for drying biomass includes a housing 102 that defines a cavity 104 configured to receive and substantially enclose biomass 103. In some embodiments, the biomass 103 to be dried can be considered “wet biomass” which, as described herein, can have a moisture content of greater than or equal to about 20% water by weight. In some embodiments, the biomass 103, before a drying operation or cycle (i.e., wet biomass) has a moisture content of about 20% to about 40% water by weight. In some embodiments, the cavity 104 can feature one or more shelves 106 or similar structures to receive and hold the biomass. Furthermore, the cavity 104 can be subsequently sealed by a door 108, thereby forming an enclosed chamber. In the embodiment of FIG. 1, the device 100 is shown having a single shelf 106 and a hinged door 108, but various numbers and arrangements of shelves 106 and door mechanisms 108 can be employed without deviating from the scope of this disclosure.

Furthermore, one or more heat sources 110 are thermally coupled to the housing 102 to allow for the transfer of heat into the housing 102 (i.e., to the cavity 104 of the housing 102 and subsequently onto any biomass (e.g., biomass 103) that is enclosed within the cavity 103 during a drying operation or cycle of the device 100. In the embodiment of FIG. 1, the heat source 110 is an electric heat source in the form of a heating element disposed within the cavity 104, but alternative selections, numbers, and/or arrangements of heat sources can be employed without deviating from the scope of the disclosure, including, but not limited to, gas heat sources (e.g., open gas flames). In some embodiments, the heat sources 110 are capable of generating a temperature within the cavity 104 (and therefore, a temperature applied to any biomass placed within) of about 37.8 degrees C. to about 148.9 degrees C. (about 100 degrees F. to about 300 degrees F.). In some embodiments, the generated temperature is about 65.6 degrees C. to about 121.1 degrees C. (about 150 degrees F. to about 250 degrees F.).

The housing 102 is furthermore fluidly coupled to a smoke producing chamber 116 by a smoke channel 118. For example, the smoke channel 118 has a first end 120 opposite a second end 122. The first end 120 is coupled to the housing 102 and the second end is coupled to the smoke producing chamber 116. The smoke channel 118 may introduce (e.g., pipe, circulate, pump, etc.) smoke into the cavity 104 from the smoke producing chamber 116 when the chamber 116 is burning materials.

For example, during a drying operation or cycle of the device 100, smoke can be generated inside the smoke producing chamber 116 (e.g., by the burning of various burnable materials such as wood chips, wood pellets, sawdust, hemp, biomass, or peat) and delivered to the cavity 104 of the housing 102 by the smoke channel 118. In the embodiment of FIG. 1, the smoke channel 118 is a pipe, but alternative constructions are possible in some embodiments.

The smoke can subsequently vacate the cavity 104 via a vent 114 located in the housing 102. Various vent structures, numbers, and arrangements can be employed without deviating from the scope of this disclosure. In the embodiment of FIG. 1, the vent 114 is a grated opening allowing for the passive diffusion of smoke. In some embodiments, the vent 114 can include a fan (not shown) or additional mechanism allowing for an active pumping or blowing of smoke from the cavity 104. In some embodiments, however, the rate of egress of smoke through the vent 114 can be such that smoke substantially fills the cavity 104 without generating substantial pressure within (i.e., the pressure inside the cavity 104 remains at approximately the local atmospheric pressure, e.g., about 1 atm (about 101 kPa)). In some embodiments, the rate of egress of smoke through the vent 114 can be such that additional internal pressure within the cavity 104 can be generated. In some embodiments, the internal pressure can reach about 0.3 atm (about 30.4 kPa) to about 1.0 atm (about 101 kPa) over local atmospheric pressure. In some embodiments, the internal pressure can reach about 0.7 atm (about 71 kPa) over local atmospheric pressure.

Inside the cavity 104, the device 100 may include at least one sensor 112a and/or other sensors 112b that can detect various physical properties of the biomass and/or physical properties of the cavity's 104 enclosed environment. Sensors 112a for detecting physical properties of an enclosed environment of the cavity 104 can include, but are not limited to, a temperature sensor, a humidity sensor, and a pressure sensor which can detect the internal temperature, humidity, and pressure, respectively. Sensors 112b for detecting physical properties of the biomass can include, but are not limited to, a spectrophotometer, an image sensor, a moisture sensor, a thermometer. In some embodiments, the spectrophotometer can measure at least a spectral reflectance of the biomass (e.g., biomass 103), while the image sensor can record photographs and detect visual changes in the biomass, including, but not limited to, color properties and/or a physical appearance of the biomass.

The moisture sensor, in some embodiments, can detect a water content within the biomass. In some embodiments, the moisture sensor detects the water content within the biomass as a weight percentage of its total weight. In some embodiments, the thermometer can measure the temperature specifically of the biomass. In some embodiments, the thermometer and/or another sensor (e.g., sensor 112a and/or sensor 112b) can calculate a brittleness temperature value for the biomass. A brittleness temperature is the temperature at which about 50% of the biomass loses structural integrity and becomes brittle according to the appropriate ASTM International test. In some embodiments, the heat source 110 of the device 100 is configured to not meet or exceed the calculated brittleness temperature value for the biomass. In the embodiment of FIG. 1, the device 100 includes two sensors 112a and 112b. In this embodiment, sensor 112a can be a cavity temperature sensor and sensor 112b can be a spectrophotometer measuring spectral reflectance of the biomass.

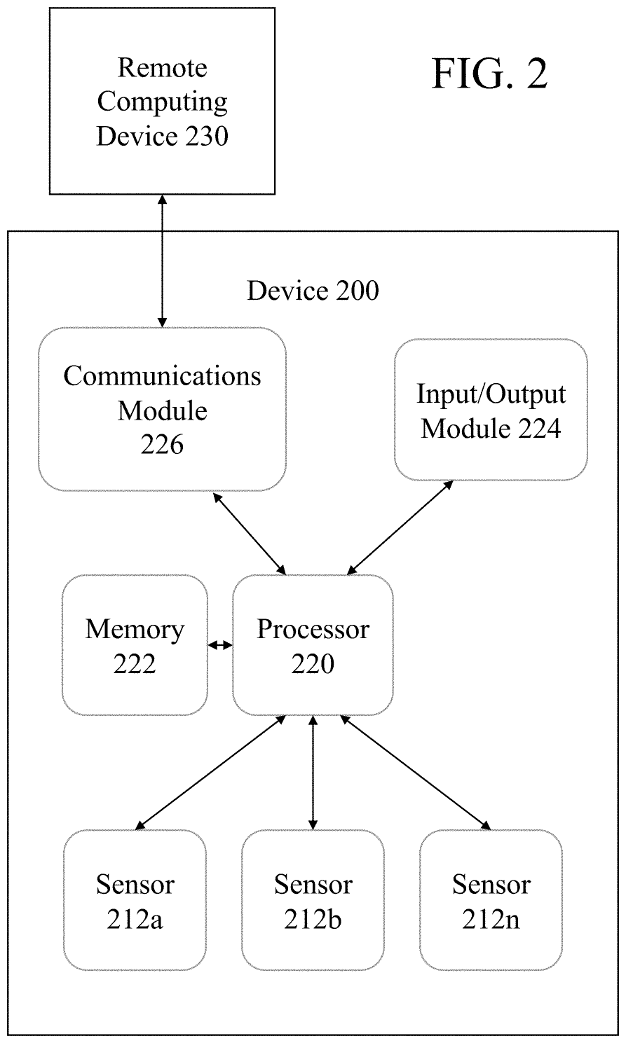

As shown in FIG. 2, an embodiment of the device 200 includes a processor 220 and a memory 222 storing non-transient machine-readable instructions that, when performed by the processor, allow for data collection and any analysis thereon by the at least one sensor 112a, 112b, 212a, 212b . . . 212n, etc. that are communicatively coupled to the processor 220. For embodiments involving a sensor (e.g., 112a, 112b, 212a, 212b . . . 212n) that detects a property of the biomass, the processor 220 can receive a signal from the sensor, process the signal, and output an indication of that parameter of the biomass. In some embodiments, the device 200 is further in communication with a remote computing device 230 (e.g., a mobile phone, networked computer, etc.) via a communication module 236. In these embodiments, the device 200 can transmit data from the at least one sensor 212a, 212b . . . 212n, etc. to the remote computing device 230, which can perform further analyses or display the data on a display (not shown) of the remote computing device or on a display 115 (FIG. 1) associated with the device 100. In some embodiments, the remote computing device 230 can also transmit any processed data or results back to the device 200.

Referring again to FIG. 1, the device 100 can additionally and optionally include display 115 which can present information to a user in various embodiments. In some embodiments, output data values (e.g., one or more spectral values, moisture content values, etc.) from the at least one sensor 112a, 112b, etc. via the processor can be displayed. In some embodiments, the displayed data values can be calculated from the processor of the device 100 (e.g., the processor 220 of device 200 of FIG. 2) and/or received from the remote computing device (e.g., the remote computing device 230 of FIG. 2). In some embodiments, the display can present other information such as a time duration of the device 100 operation (i.e., a remaining time value for a drying operation or cycle of the device 100). Additionally, in some embodiments, the display 115 can present a user interface with interactable elements such that a user using an input device (e.g., buttons, a computer mouse, a touchscreen) can input various operations and parameters thereof. Examples of such operations and parameters include, but are not limited to, the initiation and/or termination of a drying operation or cycle, a drying time duration, a drying temperature value or schedule, a desired smoke quantity or duration, etc. In some embodiments, the Input/Output module 224 of FIG. 2 may include the display 115 and one or more input devices (not shown) associated with device 100.

In this manner, a user can select and initiate a drying operation or cycle having various parameters and can subsequently observe the status of the drying operation or cycle and said parameters. In some embodiments, the drying operation or cycle has a duration of about 15 minutes to about 2 days. In some embodiments, the drying operation or cycle has a duration of about 1 day. In some embodiments, the drying operation or cycle has a duration of about 15 minutes to about 180 minutes; about 30 minutes to 90 minutes; about 60 minutes to about 70 minutes; about 70 minutes to about 80 minutes; about 80 minutes to about 90 minutes; about 90 minutes to about 120 minutes; about 120 minutes to about 150 minutes; about 150 minutes to about 180 minutes. At the completion of the drying operation or cycle, the biomass can have a total moisture content of about 10% to about 20% by weight in some embodiments. In some embodiments, at the completion of the drying operation or cycle as described herein, the biomass may have a total moisture content of about 6% to about 12% by weight. In some embodiments, at the completion of the drying operation or cycle as described herein, the biomass may have a total moisture content of about 10% by weight.

Furthermore, at the completion of the drying operation or cycle, the biomass (e.g., biomass 103) may have a substantially preserved terpene content, similar to that of the wet biomass or biomass dried by conventional methods. In some embodiments, at the completion of the drying operation or cycle, the biomass can have a desired terpene content measured as a weight ratio of specific terpene weight to total weight. In some embodiments, the biomass after drying has a total farnesenes (e.g., Trans-β-famesene) content of about 0.010% to about 0.050% by weight ratio. In some embodiments, the biomass after drying has a total farnesenes content of about 0.020% to about 0.040% by weight ratio. In some embodiments, the biomass after drying has a total nerolidol content of about 0.3% to about 0.9% by weight ratio. In some embodiments, the biomass after drying has a total nerolidol content of about 0.4% to about 0.8%. In some embodiments, the biomass after drying has a total terpineol content of about 2.0% to about 7.0% by weight. In some embodiments, the biomass after drying has a total terpineol content of about 2.5% to about 5.75% by weight. In some embodiments, the biomass after drying has a total farnesenes content of about 0.020% to about 0.040% by weight ratio, a total nerolidol content of about 0.4% to about 0.8%, and a total terpineol content of about 2.5% to about 5.75% by weight.

### Methods

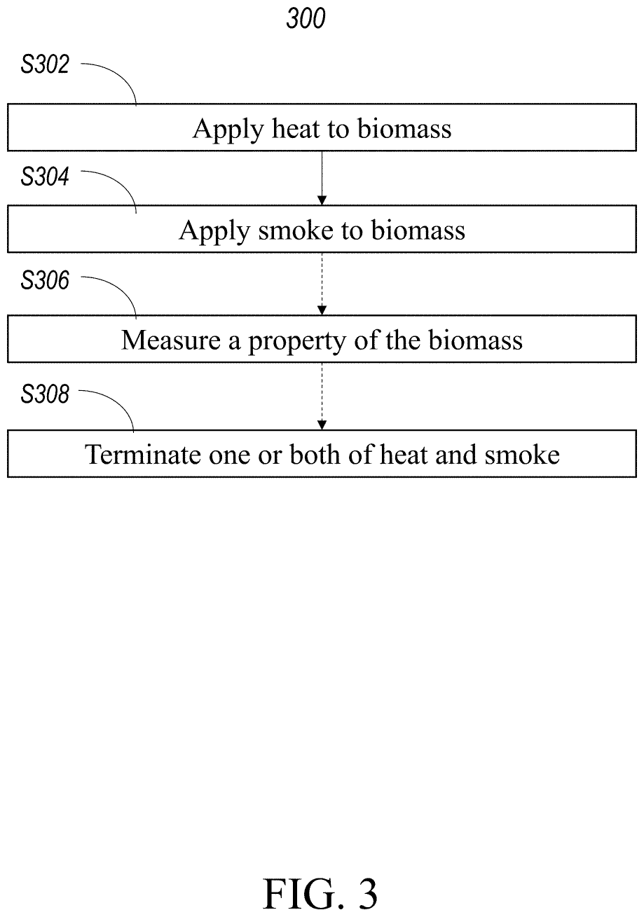

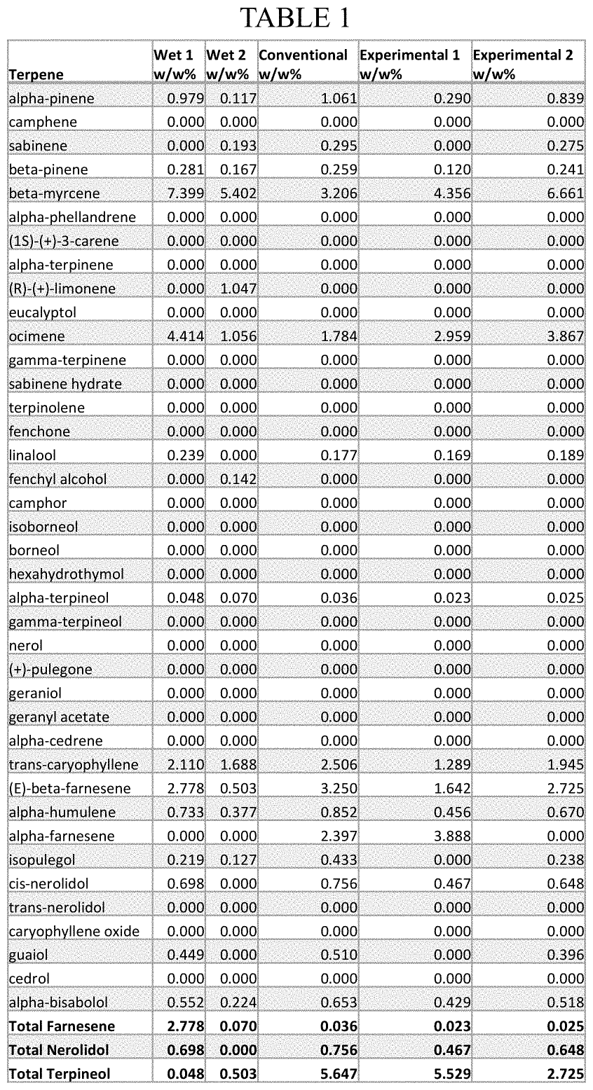

As shown in FIG. 3, an example method 300 for drying or biomass with a smoker can include applying heat to the biomass in block S302, applying smoke to the biomass in block S304, optionally measuring a property of the biomass in block S306, and terminating one or both of the heat and smoke in block S308. The method 300 may function to dry or cure plant biomass. In some embodiments, the method 300 may function to dry or cure biomass more expediently over conventional drying techniques while still preserving a desired terpene content and/or farnesenes content and/or nerolidol content.

In some embodiments, the method 300 may be used for the drying or curing of hemp (Cannabis sativa) but can additionally or alternatively be used for any suitable applications, agricultural or otherwise. For example, the method 300 can be configured to function for any suitable crop where drying or curing is desired.

In some embodiments, the method 300 can be performed with a device as described herein (e.g., the device 100 of FIG. 1); however, in some embodiments, alternative machines or arrangements can be employed without deviating from the scope of this disclosure.

As described herein, various blocks of the method 300 can be performed as a cycle, meaning that certain blocks can be repeated a variety of times (collectively or individually) without deviating from the scope of this disclosure. In some embodiments, when cycling a parameter of the device 100 (e.g., temperature, smoke quantity, etc.), the parameter can be allowed to return to ambient conditions (i.e., conditions matching those outside the device 100) or to a predetermined condition before restoring the parameter.

In some embodiments, the biomass is “wet biomass” having a moisture content of greater than or equal to about 20% water by weight. In some embodiments, the biomass has a moisture content of about 20% to about 40% water by weight. In some embodiments, the biomass has a moisture content of about 13% to about 20% water by weight. In some embodiments, the biomass includes hemp. In some embodiments, the biomass includes Cannabis. In some embodiments, the biomass includes seeds.

At block S302, the method 300 includes applying heat to the biomass. For example, the heat may be provided by the heat source 110 to the cavity 104 of device 100. In some embodiments, the provided heat may be directed toward the biomass 103 to provide a direct heat source. For example, a blowing heat source may blow hot air toward biomass 103. In some embodiments, the provided heat may be indirectly provided to heat an environment surrounding the biomass. For example, a radiating heat source may radiate heat within the cavity 104.

In some embodiments, heat is applied to the biomass at a temperature of about 37.8 degrees C. to about 148.9 degrees C. (about 100 degrees F. to about 300 degrees F.). In some embodiments, the applied temperature is about 65.6 degrees C. to about 121.1 degrees C. (about 150 degrees F. to about 250 degrees F.). In some embodiments, the temperature of the heat remains constant for the duration of the drying operation or cycle. In some embodiments, the temperature of the heat can change over the duration of the drying operation. In some embodiments, the temperature of the heat can cycle according to a predetermined schedule. In some embodiments, the temperature of the heat can adaptively change in response to detected changes in the physical properties of the biomass, as described in further detail below.

As described herein, the heat can be applied to the biomass by a variety of heat sources, including, but not limited to electric heat sources and gas heat sources. In some embodiments, the heat can be applied to the biomass under a pressure greater than ambient pressure. In some embodiments, the pressure can reach about 0.3 atm (about 30.4 kPa) to about 1.0 atm (about 101 kPa) over local atmospheric pressure. In some embodiments, the pressure can reach about 0.7 atm (about 71 kPa) over local atmospheric pressure.

At block S304, the method 300 may include applying smoke to the biomass. As described herein, a variety of technologies can be employed to produce and apply smoke to the biomass, including, but not limited to, atomizers, smokers, vaporizers, the smoke-producing chamber 116 of FIG. 1, etc. Applying smoke to the biomass 103, for example, can include burning one or more materials within the smoke producing chamber 116. The burned one or more materials may generate particles, gas, smoke, etc. of the one or more materials that may be piped via smoke channel 118 into cavity 104 of device 100. In some embodiments, the particles may function to change the atmosphere surrounding the biomass 103. The changes to the atmosphere surrounding the biomass 103 may include, but are not limited to changes in temperature, changes in humidity, changes in pressure, etc.

Any and all of the atmospheric changes may affect one or more properties of the biomass 103 including, but not limited to changes in physical appearance (e.g., color, shape, form, size, etc.), changes in brittleness and/or brittleness temperature, changes in flavor, changes in density, etc.

In some embodiments, the quantity of smoke is held constant over the duration of a drying operation or cycle. In some embodiments, the quantity of smoke can change over the duration of the drying operation or cycle according to a predetermined schedule or adaptively in response to detected changes in the physical properties of the biomass. In some embodiments, the smoke can be produced by the burning of burnable materials such as wood chips, pellets, sawdust, hemp, biomass, and/or peat. In some embodiments, the smoke can further be flavored by the addition of various flavorants. By employing a flavored smoke, the smoke can impart a flavor onto the biomass. In some embodiments, the smoke can be applied to the biomass under a pressure greater than ambient pressure. In some embodiments, the pressure can reach about 0.3 atm (about 30.4 kPa) to about 1.0 atm (about 101 kPa) over local atmospheric pressure. In some embodiments, the pressure can reach about 0.7 atm (about 71 kPa) over local atmospheric pressure.

At block S306, the method 300 may include measuring a property of the biomass. In some embodiments, the property of the biomass can be one or more of: a spectral reflectance, a color property, a moisture content, a temperature, a physical appearance, and a brittleness temperature value. The one or more properties of the biomass can be measured by one or more sensors as described herein, and those sensors can be communicatively coupled to a processor and memory in some embodiments that allow for automated data collection, analysis, and/or presentation to a user on display 115, for example.

At block S208, the method 300 may include determining whether a measurement associated with the measuring of the property is within a predefined threshold window. For example, the sensors 112a, 112b (or other sensor associated with device 100) may determine and detect particular levels associated with properties of the biomass 103.

If the property being measured is a moisture content, one or more of the sensors 112a, 112b, etc. may measure the moisture content of the biomass 103 to determine whether a level of moisture content is within the predefined threshold window. In some embodiments, the measurements may be spectral reflectance measurements. In this example, the predefined threshold window may define a moisture content of about 6% to about 12%. If the measured/detected level of moisture content within the biomass 103 is within a predefined threshold window (e.g., range) of about 6% to about 12%, the device 100 may terminate the application of one or both of the heat and the smoke. For example, in response to determining that the moisture content measurement of the biomass 103 is within the 6% to 12% threshold window, the heat and/or the smoke may be terminated, discontinued, etc.

If the property being measured is a temperature of the biomass 103, one or more of the sensors 112a, 112b, etc. may measure the temperature of the biomass 103 to determine whether a level of temperature is within the predefined threshold window. In this example, the predefined threshold window may define a temperature of about 65.6 degrees C. to about 121.1 degrees C. or about 37.8 degrees C. to about 148.9 degrees C. for a specified amount of time. If the measured/detected level of temperature of the biomass 103 is within the predefined threshold temperature window, the device 100 may terminate the application of one or both of the heat and the smoke. In some embodiments, the method 300 may end a cycle early if the property (e.g., temperature) reaches the predefined threshold window prior to completion of the cycle.

If the property being measured is a physical appearance of the biomass 103, such as color, the process 300 may assess the color of the biomass 103 over time using sensors 112a, 112b, etc. The device 100 may include a processor (e.g., processor 220) which may be communicatively coupled to the at least one sensor 112a, 112b, etc. The processor 220 may carry out instructions that include receiving a signal from the at least one sensor 112a, 112b, etc., processing the signal, and outputting an indication of the property of the biomass 103. For example, when the property is a color property of the biomass 103, the sensor 112a may be a spectrophotometer (installed in the housing 102 within cavity 104. The spectrophotometer may be configured to measure a spectral reflectance of the biomass 103 to assess the color over time.

The processor may further be programmed to compare the color to a number of colors within a predefined threshold window/range of colors to determine whether or not the detected color of the biomass 103 is within the window/range of colors. If the detected color is within the predefined threshold window/range of colors, the process 300 may include causing a ceasing of the heat source and/or causing a ceasing of the smoke producing chamber. For example, when the indication of the output of the color property of the biomass 103 indicates that at least a portion of the biomass 103 is detected to be a predefined color, the process 300 may cause a discontinuing of the heat application and/or smoke application. In some embodiments, the color property is utilized to indicate a particular moisture content. Therefore, the predefined threshold window/range may include predefined colors known to be associated with a particular and predefined moisture content corresponding to a completed drying cycle for the biomass 103.

In some embodiments, the processor may further be programmed to cause modification of operation of the heat source or modification of operation of the smoke producing chamber in response to the output/indications triggered by the measurements. The modifications can shorten or extend heat and/or smoke cycles to ensure that the process 300 achieves a desired physical appearance/color property, a desired moisture property, a desired temperature profile, or a desired brittleness temperature for the biomass 300.

If the property being measured is brittleness temperature value, the process 300 may include discontinuing one or both of the heat and the smoke when the biomass is detected via sensors 112a, 112b, etc. to be within a predefined threshold window for a brittleness temperature value to ensure that the biomass 103 does not exhibit brittleness.

Heat source 110 may be cycled to ensure that the brittleness temperature value for the biomass 300 is not reached. Cycling temperature application can function to apply heat over a longer period of time using shorter heat cycles to ensure the biomass 300 does not overheat to the point of causing brittleness.

In some embodiments, a combination of properties may be measured to determine whether each property, is within a respective predefined threshold window for that property. For example, the method 300 may include applying heat to a wet biomass at a temperature between about 65.6 degrees C. to about 121.1 degrees C. to ensure the wet biomass is modified into a dry biomass with a moisture content of about 6% to about 12%. In another example, the method 300 may include applying heat to a wet biomass at a temperature between about 37.8 degrees C. to about 148.9 degrees C. to ensure the wet biomass is modified into a dry biomass with a moisture content of about 6% to about 12%. The method 300 may further include applying smoke to the wet biomass. If a time period (e.g., about 15 minutes to about 180 minutes) of a cycle has elapsed, the method 300 may discontinue one or both of the heat and the smoke.

If the wet biomass is not within a particular predefined moisture content window (e.g., about 10% to about 20% moisture content or about 6% to about 12% moisture content), the cycle may be performed longer with one or both of the heat and the smoke. If the cycle has elapsed, the temperature threshold window is met, and the moisture content threshold window is met, the process 300 may discontinue one or both of: the heat and the smoke to the wet biomass after about 15 minutes to about 180 minutes. After the cycle, the wet biomass may be a dry biomass with moisture content of about 10% to about 20%; about 6% to about 12%; about 10% to about 12%. In some embodiments, the method 300 includes terminating the application of one or both of: the heat or smoke to the biomass after a duration of about 15 minutes to about 120 minutes. In some embodiments, one or both of: the heat or smoke is terminated after a duration of about 30 minutes to 90 minutes. In some embodiments, the drying operation or cycle has a duration of about 60 minutes to about 70 minutes; about 70 minutes to about 80 minutes; about 80 minutes to about 90 minutes; about 90 minutes to about 120 minutes; about 120 minutes to about 150 minutes; about 150 minutes to about 180 minutes.

In some embodiments, various blocks of the method 300 can be performed as a cycle. In some embodiments, this can entail reapplying heat or smoke at the same or a different value (e.g., temperature, quantity of smoke, etc.) after previous application of heat or smoke. In some embodiments, applying the heat and smoke at various values for various iterative durations can yield dry biomass having a desirable terpene content. In some embodiments, the method 300 can yield dry biomass having a desirable terpene content after only a single drying cycle. At the completion of the drying operation or cycle, the biomass can have a total moisture content of about 10% to about 20% by weight in some embodiments.

Furthermore, at the completion of the drying operation or cycle, the biomass can have a desired terpene content measured as a weight ratio of specific terpene weight to total weight. In some embodiments, the biomass after drying has a total farnesenes content of about 0.010% to about 0.050% by weight ratio. In some embodiments, the biomass after drying has a total farnesenes content of about 0.020% to about 0.040% by weight ratio. In some embodiments, the biomass after drying has a total nerolidol content of about 0.3% to about 0.9% by weight ratio. In some embodiments, the biomass after drying has a total nerolidol content of about 0.4% to about 0.8%. In some embodiments, the biomass after drying has a total terpineol content of about 2.0% to about 7.0% by weight. In some embodiments, the biomass after drying has a total terpineol content of about 2.5% to about 5.75% by weight. In some embodiments, the biomass after drying has a total farnesenes content of about 0.020% to about 0.040% by weight ratio, a total nerolidol content of about 0.4% to about 0.8%, and a total terpineol content of about 2.5% to about 5.75% by weight.

In a non-limiting example, the biomass may be cannabinoid. Heat may be applied to the cannabinoid at a temperature of about 37.8 degrees C. to about 148.9 degrees C. (about 100 degrees F. to about 300 degrees F.). In some embodiments, the applied temperature is about 65.6 degrees C. to about 121.1 degrees C. (about 150 degrees F. to about 250 degrees F.) for any time from about 15 minutes to about 180 minutes. In some embodiments, the temperature of the heat remains constant for the duration of the drying operation or cycle. In some embodiments, the temperature of the heat can change over the duration of the drying operation. In some embodiments, the temperature of the heat can cycle according to a predetermined schedule. In some embodiments, the temperature of the heat can adaptively change in response to detected changes in the physical properties of the biomass, as described in further detail below. In addition, smoke maybe applied to the cannabinoid over the same time period of about 15 minutes to about 180 minutes. The time may be selected to ensure that the cannabinoid is heated and smoked until a moisture content of the cannabinoid is between about 6% and about 12% water by weight. In some embodiments, the time may be selected to ensure that the cannabinoid is heated and smoked until the moisture content is about 10% water by weight.

### Examples

Table 1 shows the terpene content of various hemp biomass samples (plant clippings with buds and without the roots) at different stages of drying and dried by different techniques. The samples “Wet 1” and “Wet 2” were samples of hemp biomass before any drying procedure. The sample “Conventional” was a hemp biomass sample dried over seven days by conventional ambient air-drying techniques. The samples “Experimental 1” and “Experimental 2” were dried by the devices and methods (about 60 minutes at about 140 degrees Fahrenheit) as described herein. Terpene content was extracted and analyzed via GC-FID (gas chromatography-flame ionization detector) with each terpene's weight reported as a percentage of total weight of the sample. As shown in Table 1, the weight percentage values of the experimental method correlate strongly with those observed in the conventional method.

When looking at total farnesene, nerolidol, and terpineol content, all the experimental values were within a factor of 2.1 or less. Regarding individual terpenes, only four examples of the thirty-nine tested were present in the conventional technique but went undetected in at least one experimental sample, and in each of these cases, the missing terpene was found in the other experimental sample. Furthermore, in all other cases, no relative individual terpene content between the conventional and experimental samples ever exceeded a factor of 4. In this manner, no substantial difference in terpene content is generated by the method disclosed herein despite its active heating methods. Thus, the devices and methods disclosed herein provide a powerful advantage over the present conventions and allow for a more rapid drying of plant biomass with little to no change in relative terpene content.

The devices and methods of the preferred embodiment and variations thereof can be embodied and/or implemented at least in part as a machine configured to receive a computer-readable medium storing computer-readable instructions. The instructions are preferably executed by computer-executable components preferably integrated with the system and one or more portions of the processor on the smoker-dryer device and/or remote computing device. The computer-readable medium can be stored on any suitable computer-readable media such as RAMs, ROMs, flash memory, EEPROMs, optical devices (e.g., CD or DVD), hard drives, floppy drives, or any suitable device. The computer-executable component is preferably a general or application-specific processor, but any suitable dedicated hardware or hardware/firmware combination can alternatively or additionally execute the instructions.

As used in the description and claims, the singular form “a”, “an” and “the” include both singular and plural references unless the context clearly dictates otherwise. For example, the term “sensor” may include, and is contemplated to include, a plurality of sensors. At times, the claims and disclosure may include terms such as “a plurality,” “one or more,” or “at least one;” however, the absence of such terms is not intended to mean, and should not be interpreted to mean, that a plurality is not conceived.

The term “about” or “approximately,” when used before a numerical designation or range (e.g., to define a length or pressure), indicates approximations which may vary by (+) or (−) 5%, 1% or 0.1%. All numerical ranges provided herein are inclusive of the stated start and end numbers. The term “substantially” indicates mostly (i.e., greater than 50%) or essentially all of a device, substance, or composition.

As used herein, the term “comprising” or “comprises” is intended to mean that the devices, systems, and methods include the recited elements, and may additionally include any other elements. “Consisting essentially of” shall mean that the devices, systems, and methods include the recited elements and exclude other elements of essential significance to the combination for the stated purpose. Thus, a system or method consisting essentially of the elements as defined herein would not exclude other materials, features, or steps that do not materially affect the basic and novel characteristic(s) of the claimed disclosure. “Consisting of” shall mean that the devices, systems, and methods include the recited elements and exclude anything more than a trivial or inconsequential element or step. Embodiments defined by each of these transitional terms are within the scope of this disclosure.

The examples and illustrations included herein show, by way of illustration and not of limitation, specific embodiments in which the subject matter may be practiced. Other embodiments may be utilized and derived therefrom, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A device for drying biomass, comprising:
a housing defining a cavity to receive and substantially enclose the biomass;
at least one sensor in the housing and configured to measure a property of the biomass;
a heat source thermally coupled to the housing, the heat source being configured to apply heat to the cavity of the housing and to the biomass therein; and
a smoke producing chamber fluidly coupled to the housing, the smoke producing chamber being configured to receive a burnable material therein.

2. The device of claim 1, wherein:
the housing further comprises a vent; and
the smoke producing chamber is fluidly coupled to the housing by a channel having a first end opposite a second end, the first end being coupled to the housing and the second end being coupled to the smoke producing chamber.

3. The device of claim 2, wherein smoke is introduced to the cavity of the housing through the channel when the burnable material is burned within the smoke producing chamber.

4. The device of claim 1, wherein the housing further comprises a temperature sensor for measuring a temperature within the cavity of the housing.

5. The device of claim 1, further comprising a display configured to show one or more of: a temperature in the cavity of the housing and a duration of device operation.

6. The device of claim 1, wherein the at least one sensor comprises a spectrophotometer and the property comprises a spectral reflectance.

7. The device of claim 1, wherein the at least one sensor comprises an image sensor and the property comprises a color property of the biomass.

8. The device of claim 1, wherein the at least one sensor comprises a moisture sensor and the property comprises a moisture content of the biomass.

9. The device of claim 1, further comprising a processor communicatively coupled to the at least one sensor and configured to:
receive a signal from the at least one sensor,
process the signal, and
output an indication of the property of the biomass.

10. The device of claim 9, wherein the processor is further configured to cause modification of operation of the heat source or modification of operation of the smoke producing chamber in response to the output.

11. The device of claim 9, wherein:
the property is a color property of the biomass; and
the processor is further configured to:
cause ceasing of operation of the heat source and cause ceasing operation of the smoke producing chamber when the indication of the property of the biomass indicates that at least a portion of the biomass is detected to be a predefined color.

12. The device of claim 11, wherein the predefined color is associated with a predefined moisture content corresponding to a completed drying cycle for the biomass.

13. The device of claim 1, wherein the at least one sensor is a spectrophotometer installed in the housing, the spectrophotometer being configured to measure a spectral reflectance of the biomass.

14. The device of claim 1, wherein the burnable material is selected from: wood chips, wood pellets, sawdust, hemp, biomass, or peat.

15. The device of claim 1, wherein the heat source comprises one of: a gas heat source and an electric heat source.

16. A method of drying biomass using a smoker, comprising:
during a cycle:
applying heat to the biomass within a chamber, the heat being applied at a temperature between about 37.8 degrees C. to about 148.9 degrees C.; and
applying smoke to the biomass within the chamber,
wherein the cycle has a duration of about 15 minutes to about 120 minutes, and
wherein, at a completion of the cycle, the biomass has a moisture content of about 6% to about 12%.

17. The method of claim 16, wherein the biomass comprises seeds.

18. The method of claim 16, wherein the biomass comprises hemp.

19. The method of claim 18, wherein, at the completion of the cycle, the hemp comprises a total farnesenes content of about 0.020% to about 0.040% by weight ratio, a total nerolidol content of about 0.4% to about 0.8%, and a total terpineol content of about 2.5% to about 5.75% by weight.

20. The method of claim 16, wherein the biomass comprises Cannabis.

21. The method of claim 16, wherein the biomass before applying the heat and the smoke has a moisture content of about 20% to about 40%.

22. The method of claim 16, further comprising flavoring the smoke to flavor the biomass.

23. A method of drying biomass using a smoker, comprising:
applying heat to the biomass at a temperature between about 37.8 degrees C. to about 148.9 degrees C.;
applying smoke to the biomass;
measuring a property of the biomass;
in response to determining that a measurement associated with the measuring of the property is within a predefined threshold window, terminating the application of one or both of: the heat and the smoke.

24. The method of claim 23, wherein the property comprises a moisture content of the biomass;
the measurement is a spectral reflectance measurement; and
the predefined threshold window is a moisture content of about 6% to about 12%.

25. The method of claim 23, wherein the biomass comprises seeds.

26. The method of claim 23, wherein the biomass comprises hemp.

27. The method of claim 23, wherein the biomass comprises Cannabis.

28. The method of claim 23, wherein the biomass before applying the heat and the smoke has a moisture content of about 20% to about 40%.

29. The method of claim 23, further comprising flavoring the smoke to flavor the biomass.

30. The method of claim 23, wherein the property comprises a moisture content.

31. The method of claim 23, wherein the property comprises a temperature.

32. The method of claim 23, wherein the property comprises a physical appearance.

33. The method of claim 23, wherein the property comprises a brittleness temperature value.

34. A method of drying biomass using a smoker, comprising:
applying heat to a wet biomass at a temperature between about 37.8 degrees C. to about 148.9 degrees C.;
applying smoke to the wet biomass; and
discontinuing one or both of: the heat and the smoke after about 15 minutes to about 180 minutes,
wherein the wet biomass becomes a dry biomass having a moisture content of about 6% to about 12% after the completion of the application of the heat and the smoke.

35. The method of claim 34, wherein the wet biomass before applying the heat and the smoke has a moisture content of about 20% to about 40%.
